(19) United States
(12) Patent Application Publication
(10) Pub. No.: US 2008/0236760 A1
(43) Pub. Date: Oct. 2, 2008

(54) Wall board tape and mastic dispenser construction

(76) Inventor: Mark Gwizdala, Bay City, MI (US)

Correspondence Address: McColloch PLC, Suite 1, 5291 Colony Drive North, Saginaw, MI, 48638, US

(21) Appl. No.: 11/729,816

(22) Filed: Mar. 29, 2007

(51) Int. Cl. B32B 37/00; B44C 7/00

(52) U.S. Cl. 156/526; 156/575

(57) ABSTRACT

A dispenser for a flexible drywall joint tape and an adhesive mastic for securing such tape to adjacent edges of abutting wall boards comprises a housing within which is a chamber into which mastic from a source thereof may be introduced via an inlet. The housing has two spaced apart mastic outlets through which mastic from the chamber may be dispensed simultaneously. A tape passageway extends through the chamber for guiding a tape from a source thereof through a discharge opening which is positioned between the two mastic outlets. A squeegee is coupled to the housing for smoothing and spreading dispensed mastic. The arrangement is such that the tape and two layers of mastic may be dispensed simultaneously with the tape occupying a position between the mastic layers.

This invention relates to a dispenser for use in applying tape and mastic to joints between drywall boards.

### BACKGROUND OF THE INVENTION

In the construction of many buildings interior walls are composed of so-called drywall panels or boards which are secured to support members such as studs and joists. Such panels conventionally are secured to the supports in such condition that the edge of one panel abuts the edge of an adjacent panel. The confronting edges of the panels are so shaped as to form a shallow groove. To provide a smooth, finished joint between adjacent panels the groove and adjacent edges of the confronting panels have an adhesive mastic applied thereto following which a thin tape is applied in overlying condition to the mastic. Another layer of mastic then is applied in overlying relation to the tape and extends slightly beyond the opposite edges thereof. The mastic is troweled, allowed to dry and then sanded so as to form a virtually seamless joint between the confronting panels. Apparatus currently in use for establishing the joint usually requires a multi-step operation involving the application of mastic, the application of the overlying tape, and the application of the tape-overlying mastic layer, followed by smoothing or feathering and sanding of the material forming the joint.

A principal object of the invention is to provide apparatus which facilitates the taping and finishing of a joint between adjacent wall panels.

### SUMMARY OF THE INVENTION

Apparatus constructed in accordance with the presently preferred embodiment of the invention comprises a housing forming a chamber and having a partition therein which divides the chamber into two compartments. A mastic inlet is located at one end of the body and is adapted for communication with a source of mastic. The partition has openings therein which enable a portion of the mastic introduced to one compartment to be diverted through such openings to the other compartment. The partition is provided with diverters which assist in diverting such portion of the mastic to the other compartment. At the opposite end of the housing are two outlets through which mastic from the respective compartments may be discharged.

Supported by the housing is a supply of joint-covering tape. A passage-forming tube spans the housing and has an inlet at one end through which the leading end of the tape may enter the passage. The tape passes through the passage and through a discharge opening at the opposite end of the housing for application to a joint between a pair of abutting wall panels. The discharge end of the passage lies at a level between the two mastic outlets, thereby enabling mastic discharged from the two compartments to underlie and overlie the tape.

At that side of the housing which confronts the wall panels is a projecting guide which is adapted to enter the groove between two adjacent wall panels and guide the housing in its movements longitudinally of the joint.

Secured to and extending beyond that end of the housing through which the mastic and tape are discharged is a squeegee which will overlie the discharge tape in a position to spread and feather the mastic which overlies the tape so as to assist in the provision of a smooth, virtually invisible joint.

The source of mastic may be either a hand-operated or fluid or other driven pump which enables mastic to flow into the housing under such pressure as to ensure filling of the compartments with mastic and discharging mastic from such compartments at a selected rate.

### THE DRAWINGS

The preferred embodiments are illustrated in the accompanying drawings wherein:

FIG. 1 is an isometric view of one embodiment;

FIG. 2 is an isometric view of another embodiment;

FIG. 3 is an isometric view of a portion of the apparatus illustrated in FIG. 1;

FIG. 4 is a sectional view taken on the line 4-4 of FIG. 3;

FIG. 5 is a fragmentary, sectional view;

FIG. 6 is a front elevational view with some parts being shown in phantom for clarity;

FIG. 7 is an isometric view similar to FIG. 3, but illustrating a modification;

FIG. 8 is a front elevational view, with some parts shown in phantom, of a further modification;

FIG. 9 is a longitudinal sectional view; and

FIG. 10 is an isometric view of the construction shown in FIG. 8.

### THE PREFERRED EMBODIMENTS

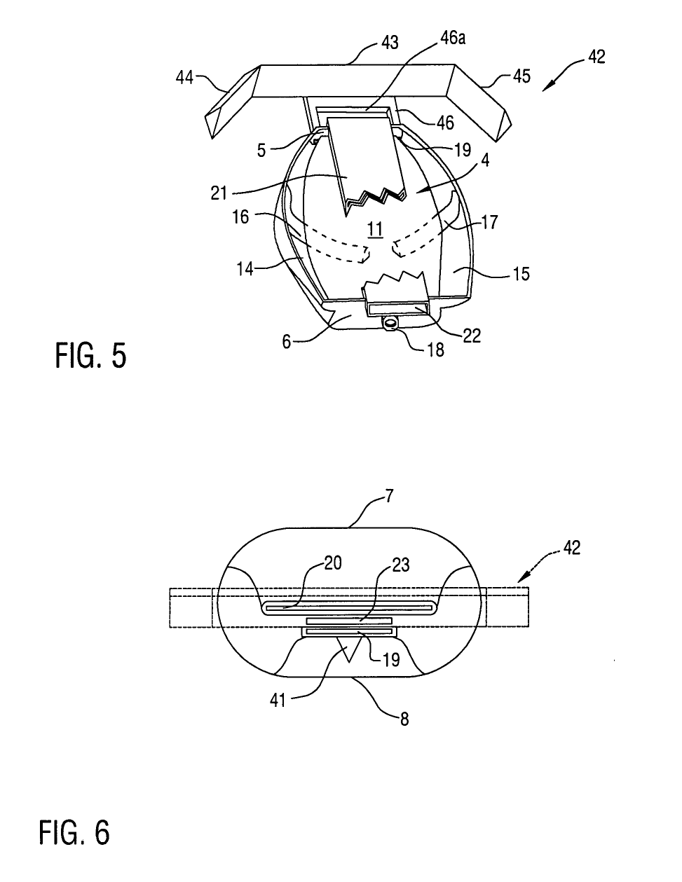

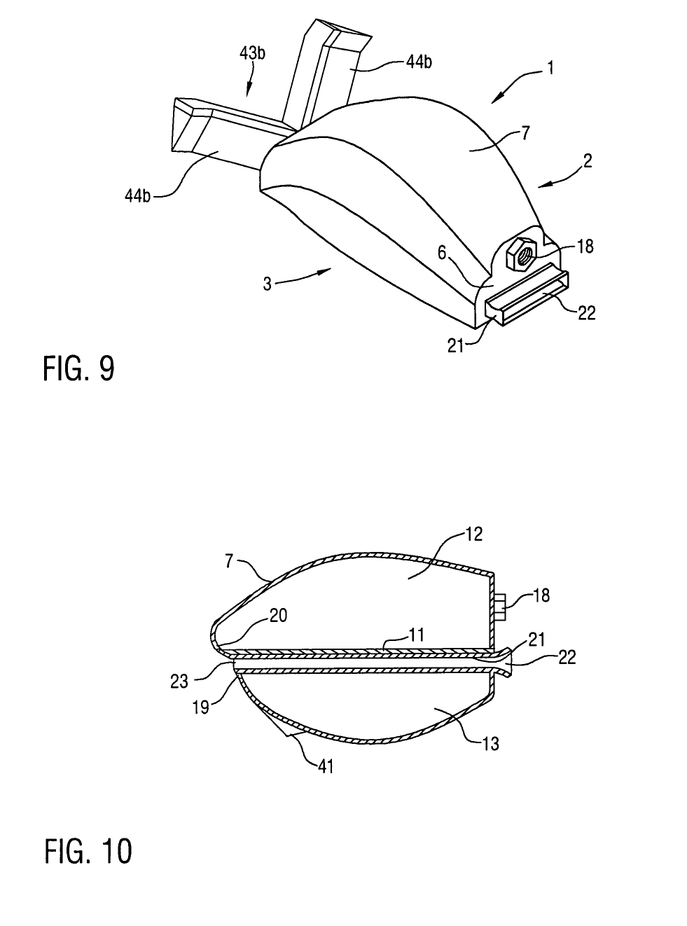

A tape and mastic dispenser according to the embodiments of the invention shown in the drawings has a housing 1 composed of upper and lower sections 2 and 3, respectively, which are secured to one another by fusion or welding in such manner as to provide an inner chamber 4 (FIGS. 4 and 5). The housing has front and rear ends 5 and 6 and top and bottom walls 7 and 8 which are so configured as to provide side walls 9 and 10. As best shown in FIG. 9 a partition 11 spans the front and rear ends and partially spans the side walls to divide the chamber 4 into two compartments 12 and 13. Openings 14 and 15 (FIG. 5) are provided at opposite sides of the partition 11 to establish communication between the upper and lower compartments. Angular diverters 16 and 17 having a space therebetween are mounted atop the partition 11.

The rear wall 6 is provided with an inlet 18 for a flowable, adhesive mastic material and the front end 5 is provided with an outlet opening 19 in communication with the lower compartment and through which mastic may flow from the lower compartment outwardly through the outlet 19. A second outlet opening 20 is provided through the front end 5 and at a level above that of the opening 19 to enable mastic to flow outwardly of the upper compartment.

Spanning the front and rear ends 5 and 6 of the housing 1 is a passage-forming, hollow sleeve 21 having a tape inlet 22 at its rear end and a tape outlet 23 at its forward end, the outlet 23 being positioned at a level between the mastic outlets 19 and 20.

The construction and arrangement of the apparatus thus far described are such that mastic admitted to the housing via the mastic inlet 18 may enter the upper compartment. A portion of such mastic will be deflected by the deflectors 16 and 17 laterally through the openings 14 and 15 into the lower compartment. The introduction of the mastic should be under such pressure as to enable a partial diversion of the mastic from the upper compartment to the lower compartment to be effected and also sufficient to enable mastic to be discharged simultaneously through the outlets 19 and 20. As is best shown in FIG. 10 the forward end of the housing forming the upper compartment 12 projects beyond and overhangs the corresponding end of the lower compartment. This enables the forward end to apply pressing force to tape dispensed from the housing.

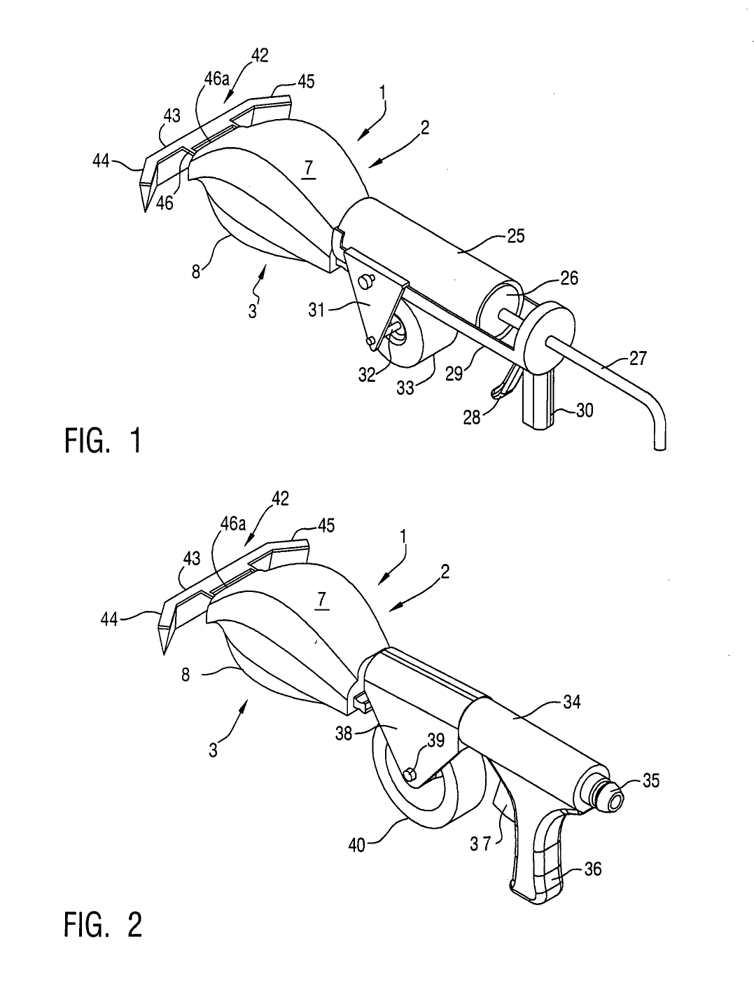

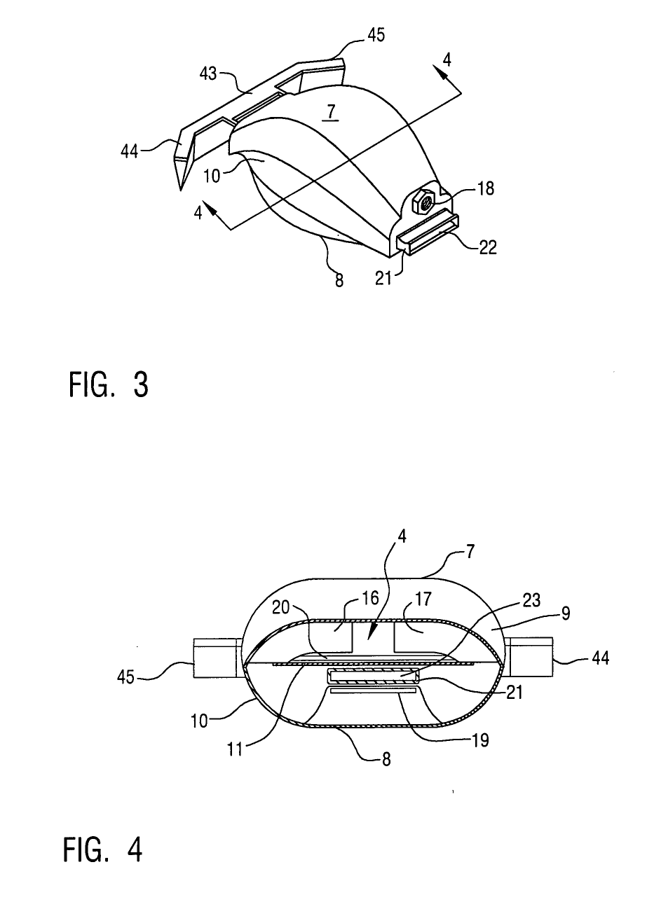

The mastic may be supplied from any one of a number of suitable sources, two of which are shown in the drawings. In FIG. 1 the mastic supply is contained within a cartridge 25 having at its forward end a nozzle (not shown) adapted for removable accommodation in the housing inlet 18. Within the cartridge is a displaceable piston 26 secured to a piston rod 27 which is movable incrementally from the rear end of the cartridge toward the forward end thereof in response to repeated actuation of a trigger 28 forming part of a conventional cartridge support frame 29 having a handle 30. The piston is capable of exerting sufficient force on the contents of the cartridge 25 as to expel the mastic from the cartridge into the inlet 18 and fill the two compartments of the housing chamber, as well as effect discharge of the mastic through the outlets 19 and 20. The cartridge is conventional and is of the kind used for the manual dispensing of mastic, caulking, or other viscous materials.

The cartridge support frame 29 is flanked by a pair of brackets 31 spanned by an axle 32 on which is journaled a roll of joint tape 33. The leading end of the tape is extended through the sleeve 21 via the inlet opening 22 and passes through the sleeve and out the outlet opening 23 so as to extend beyond the forward end of the housing 1.

Another form of mastic delivery apparatus is shown in FIG. 2 and comprises a receiver 34 having at one end thereof a nozzle (not shown) which removably may be secured in the mastic inlet 18. At the opposite end of the receiver is a fitting 35 which removably may be coupled to a delivery tube (not shown) which extends from a pressurized source of mastic that may be delivered to the housing upper compartment by means of a pump (not shown). The receiver includes a handle 36 and a manually operable valve control trigger 37 by means of which the flow of mastic into and through the receiver may be controlled. In this embodiment the receiver supports a pair of parallel brackets 38 which, in turn, support an axle 39 on which is journaled a roll of tape 40, the leading end of which may extend into and through the sleeve 21 in the same manner as that described above.

As is best shown in FIG. 6, the lower mastic outlet 19 has a side-to-side dimension corresponding substantially to that of the tape outlet 23. Consequently, mastic dispensed through the outlet 19 will be in band or ribbon form having a width corresponding substantially to the width of the tape. However, the side-to-side dimension of the mastic opening 20 is substantially greater than that of the tape outlet 23. Accordingly, the width of the band of mastic dispensed from the outlet 20 will be greater than that of the tape discharged through the tape outlet 23.

At the forward and lower end of the housing 1 is a downwardly extending projection or guide fin 41 which may enter the groove between two adjacent wall panels and guide the housing in its movement longitudinally of the groove.

A squeegee 42 is mounted at the forward end of the housing 1 and comprises a flexible member formed of rubbery, plastic, or other suitable material having a linear central section 43 terminating at its opposite ends in rearwardly angled projections 44 and 45. The squeegee 42 is secured to the forward end of the housing 1 by a frame 46.

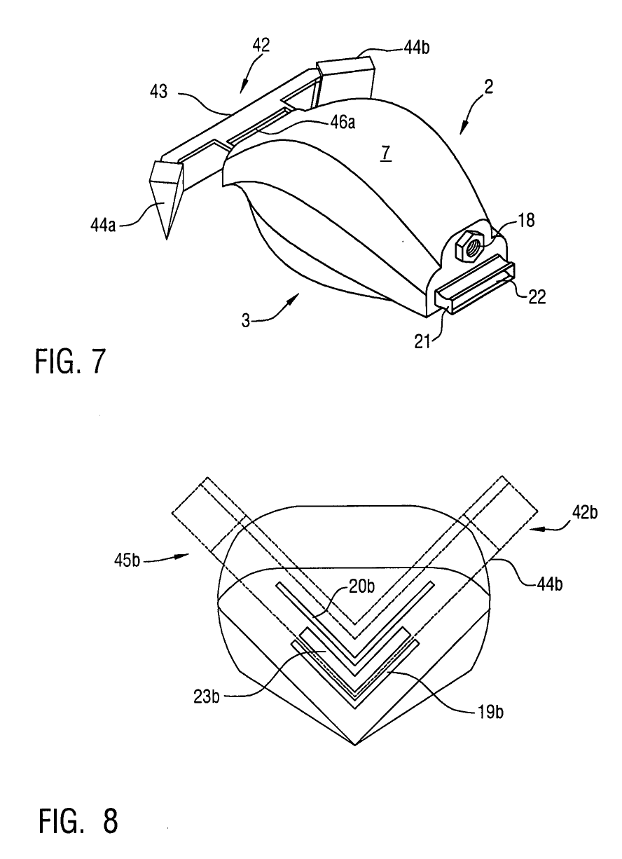

The modifications shown in FIGS. 7, 8, and 10 will be described subsequently.

In the operation of the apparatus thus far described, and regardless of whether mastic is supplied via the cartridge 25 or the receiver 34 in the manner illustrated in FIG. 1 or 2, the apparatus is conditioned for operation by extending the leading end of the tape through the housing via the passage-forming sleeve 21 so that the leading end of the tape protrudes through the outlet opening 23 thereby enabling the operator to place the tape in a position to overlie the groove between two adjacent wall panels and a portion of the edges of such panels. The two mastic compartments of the housing chamber will be filled with mastic so that the delivery of additional mastic to such compartments will enable mastic to flow simultaneously through the mastic outlets 19 and 20.

The operation may commence by supplying additional mastic to the compartments whereupon mastic will be discharged through the outlets 19 and 20 so as to supply directly to the surfaces of adjacent wall panels a lower ribbon or layer of mastic. At the same time the leading end of the tape may be applied over the lower ribbon of mastic which will underlie the tape. Another, upper layer of mastic is dispensed via the outlet 20 so as to overlie the tape and portions of the wall panels adjacent the groove. The operator may fix the free end of the tape and move the apparatus longitudinally of the two adjacent wall panels while supplying additional mastic to the housing compartments so that the underlying and overlying ribbons of mastic will be continuously applied as the apparatus moves.

Since the leading end of the tape will be fixed, additional tape unwound from the roll will occupy a position between the underlying and overlying ribbons of mastic. The underlying ribbon of mastic will adhere the tape to the confronting edges of wall panels in overlying relation to the groove therebetween, and the overlying ribbon of mastic not only will cover the upper surface of the tape, but also portions of the wall panels beyond opposite edges of the tape. As the housing traverses the joint between adjacent panels the overhanging forward end of the housing may press the tape against the lower ribbon of mastic.

As the apparatus moves longitudinally of the groove, the guide fin 41 will occupy the groove so as to ensure proper positioning of the housing relative to the confronting edges of the wall panels. The fin also assists the operator in ensuring that the housing is maintained at a proper angle to apply the ribbons of mastic properly.

As the apparatus is moved longitudinally of the confronting wall panels the squeegee 42 will bear against mastic which is atop and at the opposite edges of the tape and smooth the mastic and prepare it for subsequent sanding following drying of the mastic. The squeegee also will apply a force through the upper ribbon of mastic and the tape to ensure that the lower ribbon of mastic is fully in face-to-face engagement with the overlying tape.

Following completion of the application of the tape in bridging relation to the groove between two confronting wall panels, the tape may be cut as is conventional. To facilitate cutting of the tape the squeegee supporting frame 46 may have a slot 46a therein for the accommodation of a utility knife blade.

As the apparatus is moved longitudinally of the groove, mastic will continue to be supplied to the compartments so as to ensure proper discharge thereof through the respective mastic outlets. Since movement of the apparatus and the supply of mastic to the compartments are under the control of the operator, neither too much nor too little mastic will be dispensed.

Some wall panels simply have rounded edges which form a substantially V-shaped groove when the edges of two panels are placed in abutting condition. Other wall panels, however, may have their edges cut in such manner that, when two confronting panels are placed in abutting condition, the exposed surfaces of the panels are not always coplanar. When these conditions are encountered, the squeegee 42 may be modified by applying to either or both ends 44 and 45 hollow, removable boots 44a and 45a which are so configured that their lower extremities may bear against the adjacent wall panels on opposite sides of the channel and accommodate a tape which occupies such channel.

FIGS. 8 and 9 disclose a squeegee 42b having two linear sections 44b and 45b normal to one another, thereby enabling the squeegee to occupy a position at a corner formed by the confronting sides of two walls which are at 90° to one another. In this embodiment each of the mastic outlets 19b and 20b, as well as the tape outlet 23b, are right angular.

The disclosed embodiments are representative of presently preferred forms of the invention, but are intended to be illustrative rather than definitive thereof. The invention is defined in the claims.

I claim:

1. A dispenser construction for dispensing a flexible tape and mastic comprising a housing having a chamber therein; means for introducing into said chamber along a path mastic from a supply thereof, said chamber having two mastic outlets in communication with said chamber and through both of which mastic within said chamber may be dispensed simultaneously; and means for introducing a flexible tape from a supply thereof to said housing, said housing having a tape outlet in communication with said supply of tape and through which tape may be discharged from said housing, said tape outlet occupying a position between said mastic outlets.

2. The construction according to claim 1 including means forming a passageway through said housing for said tape, said passageway being in communication with said tape outlet.

3. The construction according to claim 1 wherein said housing has a partition therein dividing said chamber into two compartments, said partition having openings adjacent opposite sides of said housing through which a portion of said mastic may pass from one compartment into the other compartment.

4. The construction according to claim 3 including diverting means in the path of mastic introduced to said one compartment for diverting said portion of said mastic to the other compartment.

5. The construction according to claim 1 including squeegee means carried by said housing for spreading mastic dispensed from said chamber via one of said outlets.

6. The construction according to claim 5 wherein said squeegee means is of such length as to extend beyond opposite sides of said housing.

7. The construction according to claim 7 wherein said squeegee means has a linear body having terminal ends and wherein said terminal ends are angularly displaced relative to said body.

8. The construction according to claim 1 wherein said supply of tape comprises a roll thereof and including means for coupling said roll to said housing.

9. The construction according to claim 1 including mastic supply means coupled to said housing.

10. The construction according to claim 9 wherein said mastic supply means includes means for introducing mastic to said chamber under sufficient pressure to enable mastic to flow through said chamber via said inlet and said outlets.

11. The construction according to claim 1 including a guide fin carried by said housing and projecting beyond the latter.

12. A dispenser construction for dispensing simultaneously tape from a supply thereof and mastic from a supply thereof onto a surface, said construction comprising a housing defining a chamber; a partition within said housing and dividing said chamber into first and second compartments; a mastic inlet in communication with said first compartment; a first mastic outlet in communication with said first compartment; a second mastic outlet in communication with said second compartment, said partition having at least one opening therein establishing communication between said first and second compartments for enabling a portion of mastic introduced to said first compartment to enter said second compartment; tape support means coupled to said housing for supporting a supply of tape; passage-forming means extending through said housing for guiding a tape from said supply thereof into, through, and out of said housing at a level between said first and second mastic outlets; means for introducing mastic into first compartment under sufficient pressure to enable mastic to occupy said first and second compartments and be discharged via said first and second mastic outlets; and squeegee means carried by said housing and projecting beyond opposite sides of the latter for engaging and spreading mastic discharged via one of said mastic outlets onto a surface underlying said housing.

13. The construction according to claim 12 including diverting means within said housing for diverting a portion of mastic introduced to said first compartment via said inlet into said second compartment.

14. The construction according to claim 12 including means for supporting a roll of tape in position to enable its leading end to enter said passage.

15. The construction according to claim 12 wherein said squeegee means is of uniform height.

16. The construction according to claim 12 wherein said squeegee means has a central section of uniform height and terminal sections at its opposite ends having a height greater than that of said central section.

17. The construction according to claim 12 wherein said squeegee means has a central section and terminal sections at opposite ends of said central section, said terminal sections being angularly displaced relative to said central section.

18. The construction according to claim 12 wherein said squeegee means has two sections joined to and extending at a right angle from one another.

19. The construction according to claim 12 including a projecting fin carried by said housing and extending beyond said housing.
